(19) United States
(12) Patent Application Publication
(10) Pub. No.: US 2018/0075118 A1
(43) Pub. Date: Mar. 15, 2018

(54) REPLICATION QUEUE HANDLING

(71) Applicant: SAP SE, Walldorf (DE)

(72) Inventors: Gabriela Bellemann de Leon, St. Leon-Rot (DE); Gunilla Carbol, Leopoldshafen (DE); Gisella Dominguez Anzuinelli, Sankt Leon-Rot (DE); Eva Angelina Hase, St. Leon-Rot (DE); Nicolai Michaelis, Heidelberg (DE); Lorenz Pfeil, Bruchsal (DE); Michael Rosier, Menden (DE); Mattias Richter, Sinsheim (DE); Frank Schuhmacher, St. Leon-Rot (DE); Mathias Schoenecker, Hambrucken (DE)

(21) Appl. No.: 15/266,025

(22) Filed: Sep. 15, 2016

(51) Int. Cl. G06F 17/30

(52) U.S. Cl. CPC G06F 17/30575; G06F 17/30368; G06F 17/30371

(57) ABSTRACT

A system includes identification of a first entry of a replication queue, the first entry associated with a first set of data of the plurality of sets of data, acquisition of the first set of data from the first memory, determination of whether the acquired first set of data comprises currently-valid data, and, if it is determined that the acquired first set of data comprises currently-valid data, export of the currently-valid data as an instance of its respective logical object to a second database system.

### BACKGROUND

Enterprise software systems receive, generate, and store data related to many aspects of an enterprise. Some systems are capable of storing data in association with time periods during which the data was, is, and/or will be valid. For example, for a given person, a system may store a first address which is associated with a past time period, a second address associated with a current time period, and a third address associated with a future time period.

It may be desirable to export stored data to an external system, e.g., for redundancy, specialized access, specialized processing, etc. However, some external systems are not capable of storing time-dependent data. Systems are therefore desired to facilitate export of time-dependent data to a system which does not support such data.

### BRIEF DESCRIPTION OF THE DRAWINGS

FIG. 1 is a block diagram of a system architecture according to some embodiments.

FIG. 2 illustrates portions of business object instances according to some embodiments.

FIG. 3 is a tabular representation of a portion of a replication queue according to some embodiments.

FIGS. 4A and 4B comprise a flow diagram of process steps according to some embodiments.

FIGS. 5-16 comprise tabular representations of portions of a replication queue according to some embodiments.

FIG. 17 is a block diagram of a system architecture according to some embodiments.

FIG. 18 is a block diagram of a computing system according to some embodiments.

### DETAILED DESCRIPTION

The following description is provided to enable any person in the art to make and use the described embodiments. Various modifications, however, will remain readily apparent to those in the art.

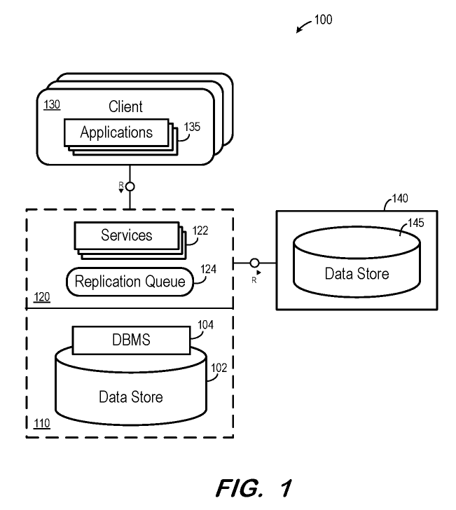

FIG. 1 is a block diagram of architecture 100 according to some embodiments. Embodiments are not limited to architecture 100 or to a database architecture. Architecture 100 includes database 110, server 120, clients 130 and snapshot database 140.

Database 110 includes metadata defining business objects. A business object is a collection of data related to a type of logical entity such as, for example, an employee or an organization. Each business object associates one or more physical entities (e.g., associated columns of one or more database tables) with attributes (e.g., Address, Name) of its logical entity. Each instance of a business object (e.g., an Employee or Organization business object) consists of data of a specific logical entity (e.g., a specific employee or a specific organization).

The metadata may be stored in data store 102 and/or a separate repository (not shown). Data store 102 stores instance data for the business objects defined by the metadata. For example, the metadata may define an Employee business object and data store 102 may store individual employee data in database tables based on the Employee business object.

Database 110 may support time-dependent instance data, in which some attributes of some business objects may be associated with one or more validity periods. The validity period(s) may be in the past, present, and/or future. For example, a particular attribute (e.g., a particular employee's home address) may be associated with data stored in data store 102 which was valid in the past (i.e., the employee's former home address) and data stored in data store 102 which is currently valid (i.e., the employee's current home address).

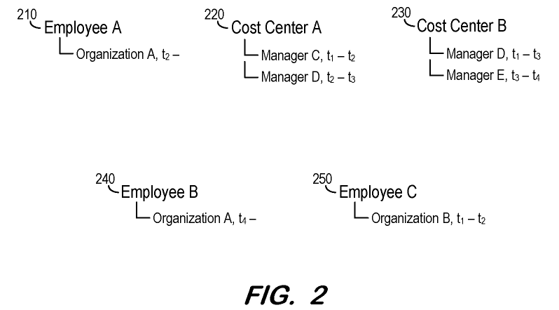

FIG. 2 illustrates time-dependent business object instance data 210-250 according to some embodiments. Instance data 210-250 may be stored in data store 102 of database 110, and FIG. 2 shows only a portion of the data of each instance 210-250. Instance data 210 is an instance of an Employee business object and is associated with a specific employee, Employee A. As shown, instance data 210 includes the value “Organization A” (i.e., corresponding to the Organization attribute of the Employee object) and associates the value with a validity period of t₂-.

Instance data 220 is an instance of a Cost Center business object and is associated with a specific cost center, Cost Center A. Instance data 220 includes the value “Manager C” (i.e., corresponding to the Manager attribute of the Cost Center object), associated with a validity period of t₁-t₂ and the value “Manager D” (also corresponding to the Manager attribute of the Cost Center object), associated with a validity period of t₂-t₃. Similarly, instance data 230 is associated with a specific cost center, Cost Center A and includes the value “Manager D” associated with a validity period of t₁-t₃ and the value “Manager D” associated with a validity period of t₃-t₄.

Instance data 240 and 250 are each instances of an Employee business object and are associated with Employee B and Employee C, respectively. Instance data 240 includes the value “Organization A” and associates the value with a validity period of t₄-, while instance data 250 includes the value “Organization B” and associates the value with a validity period of t₁-t₂.

In contrast, snapshot database 140, which includes data store 145, does not support time-dependent data. For example, the values stored within snapshot database 140 for each attribute of a business object instance are either not time-associated or are all associated with a single time. Snapshot database 140 may be intended to store a “snapshot” of the currently-valid data of data store 102. Exporting instance data from database 110 to snapshot database 140 therefore requires consideration of the time-dependencies of the data of database 110.

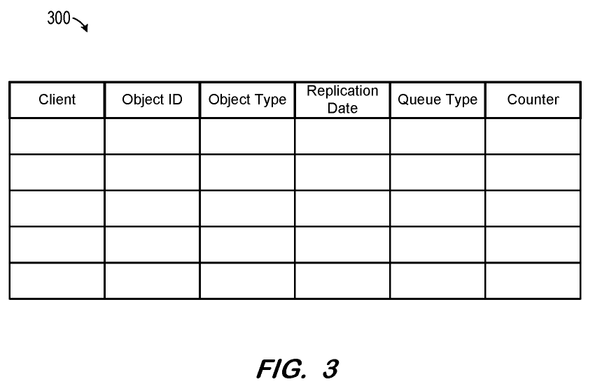

According to some embodiments, replication queue 124 of server 120 facilitates the export of instance data of data store 102 to snapshot database 140. FIG. 3 is a tabular representation of a portion of replication queue 124 according to some embodiments. Each row of replication queue 124 represents a business object instance to be exported to snapshot database 140.

Usage of the data of replication queue 124 according to some embodiments will be described in detail below. Generally, the Client column may store an identifier of a database to which instance data is to be exported (e.g., snapshot database 140). The Object ID and Object Type columns specify, respectively, the instance and the type of business object associated with the row. The Replication Date column indicates a date on which export of the instance data is to occur, the Queue Type column indicates whether a row represents a failed or future export, and the Counter column tracks a number of attempts to export the instance which have occurred.

Returning to FIG. 1, each of data stores 102 and 145 may comprise a relational database, a multi-dimensional database, an eXtendable Markup Language (XML) document, or any other data storage system storing structured and/or unstructured data. The data of data stores 102 and/or 145 may be distributed among several relational databases, dimensional databases, and/or other data sources.

In some embodiments, the data of data store 102 and/or data store 145 may comprise one or more of conventional tabular data, row-based data, column-based data, and object-based data. Moreover, the data may be indexed and/or selectively replicated in an index to allow fast searching and retrieval thereof.

Database 110 and/or database 140 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

Server 120 may execute and provide services 122 to applications 135. Services 122 may comprise server-side executable program code (e.g., compiled code, scripts, etc.) which provide functionality to applications 135 by providing user interfaces to clients 130, receiving requests from applications 135, retrieving data from data store 102 based on the requests, processing the data received from data store 102, and providing the processed data to applications 135. Services 122 may be made available for execution by server 130 via registration and/or other procedures which are known in the art.

Server 120 provides any suitable protocol interfaces through which applications 135 executing on clients 130 may communicate with services 122 executing on application server 120. For example, server 120 may include a HyperText Transfer Protocol (HTTP) interface supporting a transient request/response protocol over Transmission Control Protocol (TCP), and/or a WebSocket interface supporting non-transient full-duplex communications between server 120 and any clients 130 which implement the WebSocket protocol over a single TCP connection.

One or more services 122 executing on server 120 may communicate with DBMS 104 using database management interfaces such as, but not limited to, Open Database Connectivity (ODBC) and Java Database Connectivity (JDBC) interfaces. These types of services 122 may use Structured Query Language (SQL) to manage and query data stored in data store 102.

DBMS 104 serves requests to query, retrieve, create, modify (update), and/or delete data of data store 102. In this regard, database 110 may comprise any query-responsive data source or sources that are or become known, including but not limited to a structured-query language (SQL) relational database management system. DBMS 104 also performs administrative and management functions, such as but not limited to snapshot and backup management, indexing, optimization, garbage collection, and/or any other database functions that are or become known. DBMS 104 may also provide application logic, such as database procedures and/or calculations, according to some embodiments. This application logic may comprise scripts, functional libraries and/or compiled program code.

As illustrated, server 120 may be separated from or closely integrated with database 110. A closely-integrated server 120 may enable execution of services 122 completely on the database platform, without the need for an additional server. For example, according to some embodiments, server 120 provides a comprehensive set of embedded services which provide end-to-end support for Web-based applications. The services may include a lightweight web server, configurable support for Open Data Protocol, server-side JavaScript execution and access to SQL and SQLScript.

Each of clients 130 may comprise one or more devices executing program code of an application 135 for presenting user interfaces to allow interaction with server 120. The user interfaces of applications 135 may comprise user interfaces suited for reporting, data analysis, and/or any other functions based on the data of data store 102.

Presentation of a user interface as described herein may comprise any degree or type of rendering, depending on the type of user interface code generated by server 120. For example, a client 130 may execute a Web Browser to request and receive a Web page (e.g., in HTML format) from application server 120 via HTTP, HTTPS, and/or WebSocket, and may render and present the Web page according to known protocols. One or more of clients 140 may also or alternatively present user interfaces by executing a standalone executable file (e.g., an .exe file) or code (e.g., a JAVA applet) within a virtual machine. In another method, one of more of clients 130 execute applications 135 loaded from server 120, that receive data and metadata by requests to services 122 executed on the server 120. Data and metadata is processed by the applications 135 to render the user interface on the client 130.

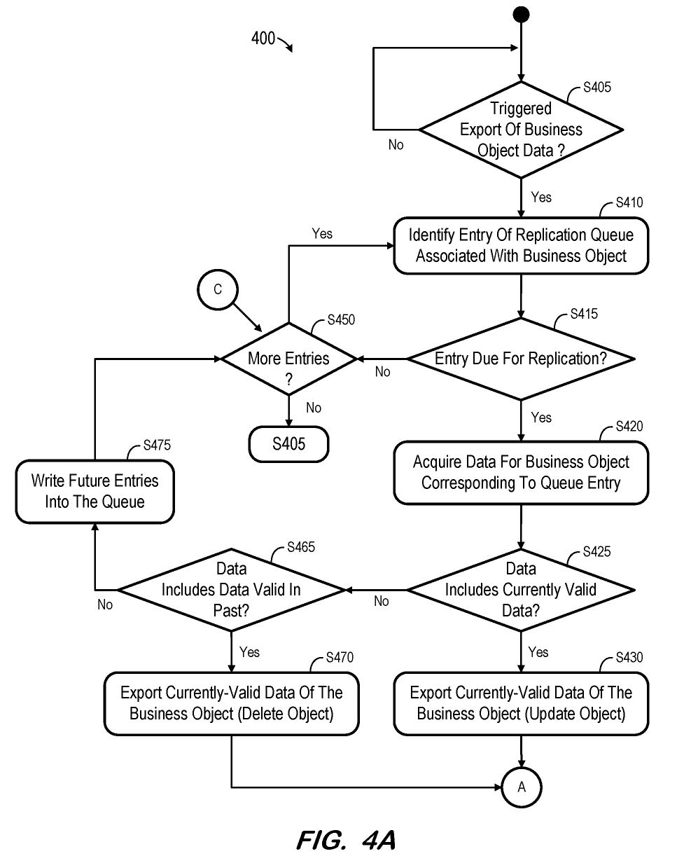

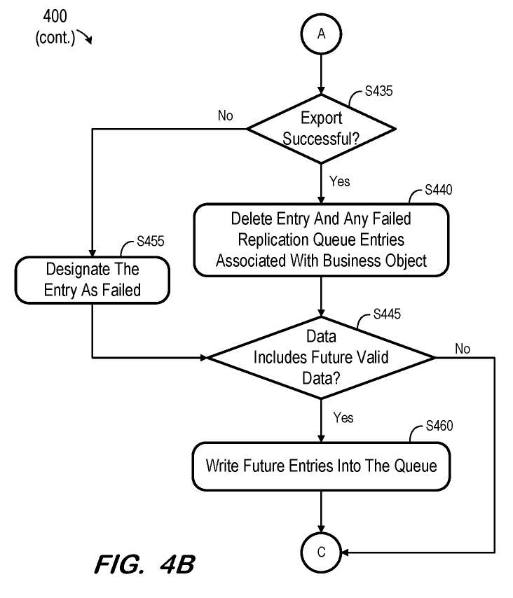

FIGS. 4A and 4B comprises a flow diagram of process 400 according to some embodiments. In some embodiments, various hardware elements of database 110 and/or server 120 execute program code to perform process 400. Process 400 and all other processes mentioned herein may be embodied in computer-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S405, it is determined whether an export of business object data has been triggered. The export of business object data may be a scheduled event, for example, a scheduled report for exporting business object data. Export of business object data may be also or alternatively triggered manually via a command from a database administrator. Flow proceeds to S410 if it is determined that an export of business object data has been triggered.

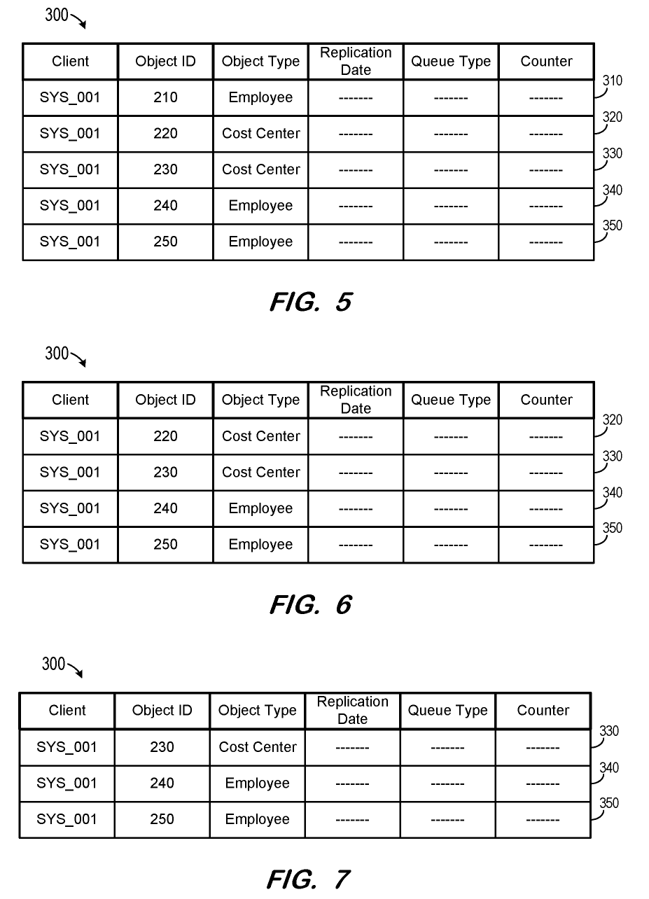

An entry of a replication queue is identified at S410. The entry is associated with a business object. FIG. 5 illustrates entries 310-350 of replication queue 300 according to some embodiments. Each of entries 310-350 is associated with a business object identified within the Object ID column of queue 300. For purposes of example, the Object ID values of replication queue 300 refer to the reference numerals of business object instance data shown in FIG. 2.

An entry may be added to replication queue 300 in any suitable manner. For example, an entry may be added every time the data of a business object instance is changed within data store 102. In some embodiments, entries are added periodically, with entries added for all changes to business object instance data which have occurred since a last addition of entries.

According to the present example, entry 310 is identified at S410. The Client value SYS_001 is assumed to refer to snapshot database 140. Embodiments are not limited to a single export client system within a replication queue. At S415, it is determined whether the identified entry is due to be replicated. Since entry 310 includes no value in the column Replication Date, it is determined that the entry is due for replication. In some embodiments, a flag or other value may be entered in the Replication Date column during creation of an entry which indicates that the entry is currently due for replication.

Data for the business object instance corresponding to the queue entry is acquired at S420. As described with respect to FIG. 2, some attributes of the instance may be associated with data associated having different validity periods. All data of the instance, including data associated with all validity periods, is acquired at S420.

Continuing with the present example, the data of business object instance 210 is acquired at S420. The data validity period of the data “Organization A” is shown as t₂-. It will be assumed that t₁ corresponds to Jan. 1, 2016, t₂ corresponds to Jul. 1, 2016, t₃ corresponds to Oct. 1, 2016, and t₄ corresponds to Jan. 1, 2017. It will also be assumed that the current date is Aug. 1, 2016.

At S425, it is determined whether the acquired data includes currently-valid data. Since the current date is within the validity period of t₂-, flow proceeds to S430 to export the currently-valid data of the business object instance. Although data of a single attribute is described in the present example, it should be noted that all currently-valid data of the instance is exported at S430. Such an export may comprise any method for exporting data to a system that is or becomes known. For example, server 120 may call an Update Object method of snapshot database 140 at S430 in order to export all of the currently-valid data of the business object instance.

Snapshot database 140 may return an indication of whether or not the export was successful. If so, flow proceeds to S435 to delete the replication queue entry, as shown in FIG. 6. S430 also includes deletion of any entries of the replication queue which are associated with the same business object instance and having a Queue Type value of “failed”. Usage of this latter mechanism will be described below.

It is then determined at S445 whether the acquired instance data includes data associated with a validity period occurring only in the future. For example, the data “Organization A” is associated with a data validity period of t₂-, which includes the current time period as well as future periods. This data would not be consider as being associated with a validity period occurring only in the future. It will be assumed that business object instance 210 does not include any other data associated with a validity period occurring only in the future and flow therefore proceeds to S450 to determine whether the replication queue includes additional entries. If so, flow returns to S410.

Continuing the present example, entry 320 of queue 300 of FIG. 6 is identified at S410. The entry is associated with business object instance 220 and is due for replication. Accordingly, the data of business object instance 220 is acquired at S420. The data includes data (i.e., Manager C) which is only valid in the past (i.e., t₁-t₂), and data (i.e., Manager D) which is currently valid (i.e., t₂-t₃). Flow therefore proceeds to S430 to export the currently-valid data (i.e., Manager D and any other currently-valid data) as described above.

Assuming the export is determined to be successful at S435, entry 320 is deleted at S440 as shown in FIG. 7. No entries designated with “failed” are associated with instance 220 therefore no such entries are deleted at S440. Moreover, since instance 220 does not include any data valid only in the future, flow returns to S450.

Entry 330 of FIG. 7 is next identified at S410. Entry 330 is associated with business object instance 230 and is due for replication. The data of business object instance 230 is therefore acquired at S420. The acquired data includes data (i.e., Manager D) which is currently valid (i.e., t₁-t₃), and data (i.e., Manager E) which is only valid in the future (i.e., t₃-t₄). It is determined that the data includes currently-valid data at S425 and the currently-valid data (i.e., Manager D and any other currently-valid data) is exported to snapshot database 140 at S430 as described above.

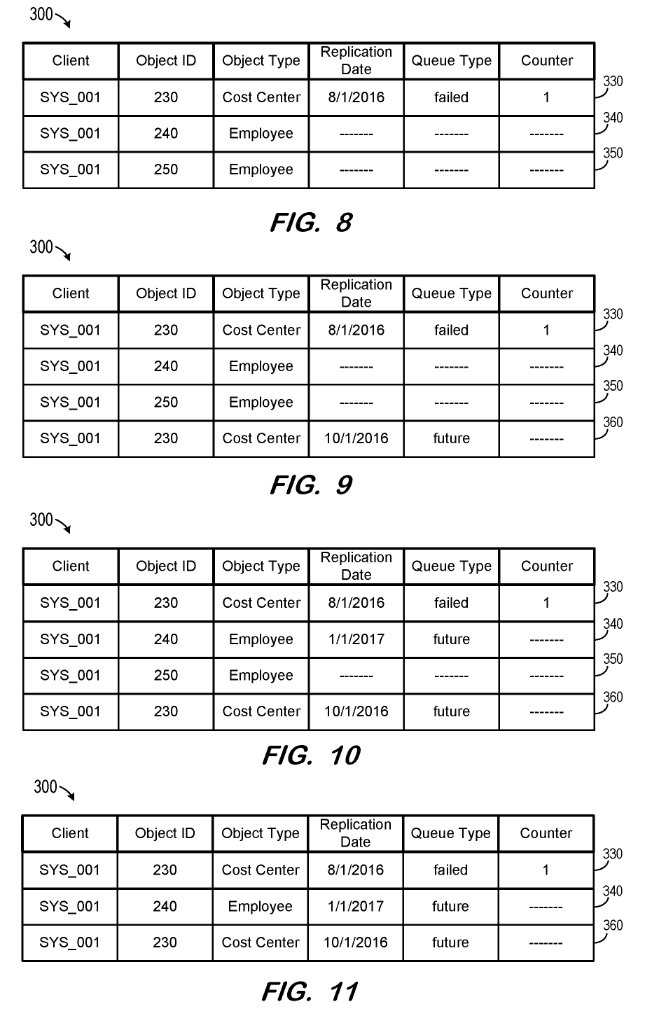

It will now be assumed that the export of currently-valid data of instance 230 is determined to have failed at S435. As a result, the entry is designated with “failed” at S455, as shown in FIG. 8. A replication date of Aug. 1, 2016 (i.e., the current day) is associated with the entry, although embodiments are not limited to using the current date.

Next, at S445, it is determined that the acquired data of instance 230 includes data which is valid in the future (i.e., but not currently valid). Accordingly, at S460, a “future” entry corresponding to this data is written into the replication queue. FIG. 9 shows entry 360, which is associated with business object instance 230 and a replication date of t₃ (i.e., Oct. 1, 2016). If the data of instance 230 included additional data which is valid during a second future period (e.g., Manager F, t₄-t₅), a separate replication queue entry would be written at S460 for this data.

After returning to S450, entry 340 of queue 300 of FIG. 9 is identified at S410. The entry is associated with business object instance 240 and is also due for replication. The data of business object instance 240 is acquired at S420, and includes data (i.e., Organization A) which is only valid in the future (i.e., t₄-). The determination at S425 is therefore negative and flow proceeds to S465 to determine whether the data includes data which is valid in the past. The determination at S465 is also negative, causing flow to proceed to S475.

Entry 340 is indicated as a “future” entry at S475, along with a replication date of t₄ (i.e., January 1, 2017), as shown in FIG. 10. If the data of instance 240 included additional data which is valid during another future period, a separate replication queue entry would be written at S460 for this data. Flow then continues to S450 to determine if any other entries exist.

Entry 350 of queue 300 of FIG. 10 is then identified at S410. Entry 350 is associated with business object instance 250 and is determined to be due for replication at S415. The data of business object instance 250 is acquired at S420. The acquired data includes data (i.e., Organization B) which is only valid in the past (i.e., t₁-t₂). The determination at S425 is negative and flow proceeds to S465 to determine whether the data includes data which is only valid in the past. Since the acquired data of business object instance 250 is only valid in the past, flow proceeds to S470 to perform an export of the currently-valid data. None of the data is currently valid, so the export effectively comprises an instruction to delete any corresponding object instance data from snapshot database 140.

Flow continues to S435 to determine whether the export was successful. It will be assumed that the export (i.e., deletion) was successful and flow therefore proceeds to S440. The current entry is deleted at S440, as illustrated in FIG. 11. Moreover, since object instance data 250 does not include any future-valid data, flow proceeds from S445 to S450.

Entry 360 of FIG. 11 is then identified at S410. The replication date of entry 360 is in the future, so flow proceeds from S415 to S450. Flow then returns to S405 because the end of replication queue 300 has been reached.

It is now assumed that another export of business object data has been triggered at S405. For ease of explanation, it is also assumed that the trigger occurs on the same date as the above-described processing, Aug. 1, 2016, and that replication queue 300 has remained in the same state as shown in FIG. 11, i.e., no entries have been added since the above-described processing. Entry 330 of FIG. 11 is therefore initially identified at S410.

As described above with respect to the processing of entry 330, entry 330 is determined to be due for replication at S415 and its corresponding business object instance data is acquired at S420. It will again be assumed that the export of the currently-valid data of instance 230 fails. Since failed entry 330 already exists for this object ID, the counter of entry 330 is incremented at S455. Moreover, since future entry 360 already exists for instance 330, an additional entry is not written at S460 and flow returns to S450 to determine if additional entries exist.

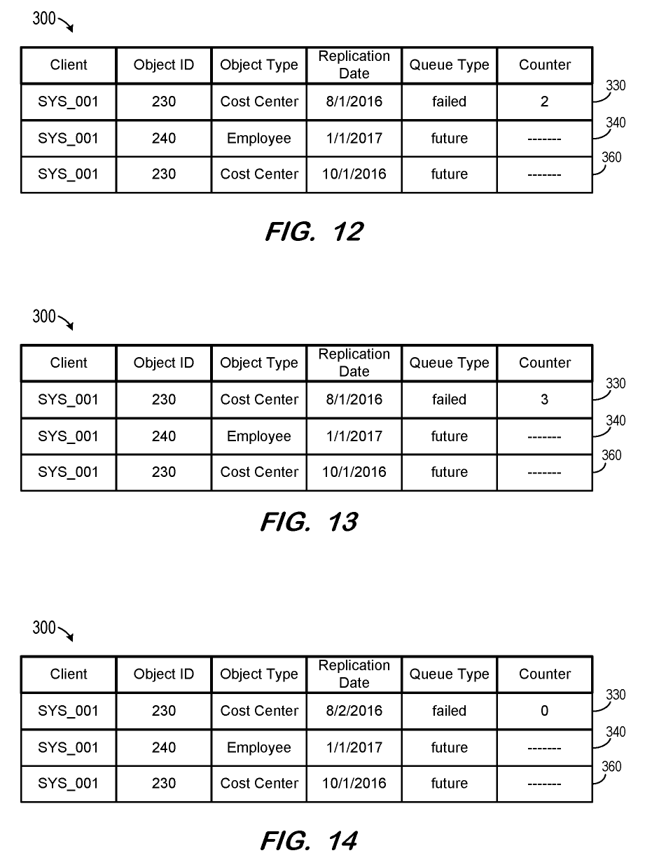

Entries 340 and 360 of FIG. 12 are not yet due for replication, therefore flow cycles through S410, S415 and S450 twice before returning to S405 to await another trigger. Another triggering event is assumed to occur on Aug. 1, 2016, with replication queue 300 in the same state as shown in FIG. 12. It will again be assumed that the export of the currently-valid instance data of object 230 has failed, causing the associated counter to be incremented to “3” as shown in FIG. 13. Entries 340 and 360 of FIG. 13 are still not due for replication, therefore flow cycles through S410, S415 and S450 twice before returning to S405 to await another trigger.

FIG. 14 shows replication queue 300 after another triggering event which occurs on Aug. 1, 2016. The export of the currently-valid instance data of object 230 has again failed, but instead of incrementing the associated counter at S455, the replication date is changed to the next day, Aug. 2, 2016, and the counter is reset to 0. The number of failures allowed per day and the retry interval (i.e., one day in the present example) may be configurable in some embodiments. Again, since entries 340 and 360 of FIG. 14 are still not due for replication, flow cycles through S410, S415 and S450 twice before returning to S405.

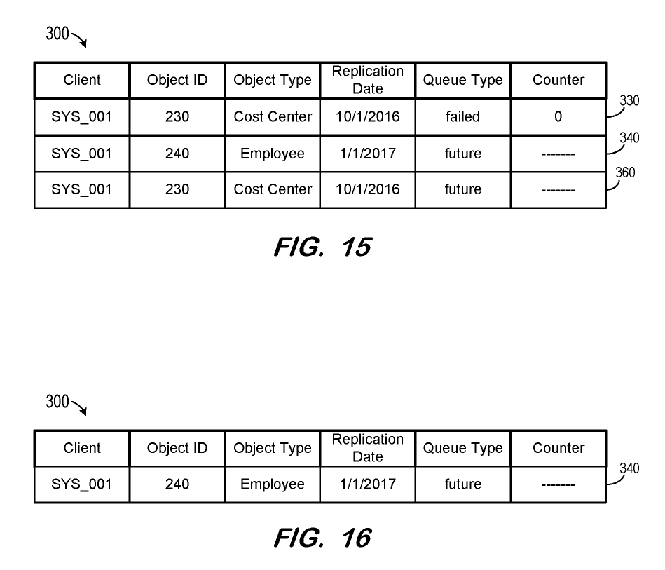

Flow may continue as described above, where the export of the currently-valid data of instance 230 repeatedly fails, until a trigger occurs on t₃, Oct. 1, 2017. For simplicity, it is assumed that replication queue 300 at this time is as shown in FIG. 15.

It is determined that entry 330 is due for replication at S415 and data of business object instance 230 is acquired at S420. It is determined at S425 that the acquired data includes currently-valid data (i.e., Manager E) and this data is exported at S430. Upon determination that the export was successful at S435, failed entry 330 and entry 360, which is also associated with instance 230, are deleted at S440. FIG. 16 shows replication queue 300 after deletion of entries 330 and 360. Entry 340 of FIG. 16 is processed as described above, with export of the data of instance 240 occurring in response to a trigger event on Jan. 1, 2017.

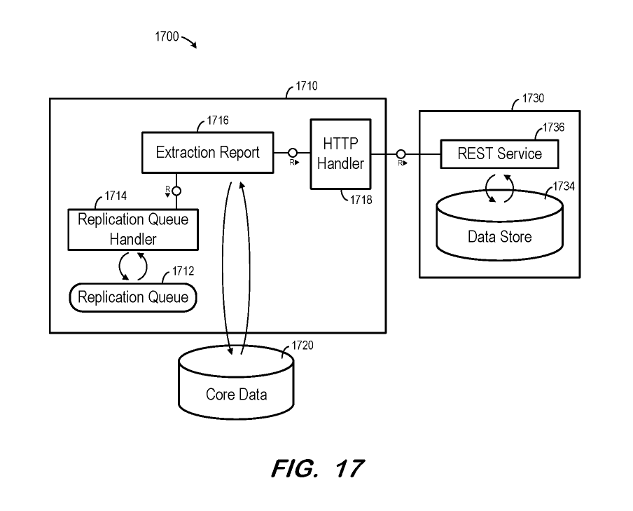

FIG. 17 is an architecture diagram of system 1700 according to some embodiments. System 1700 may comprise an implementation of database 110, server 120 and snapshot database 140 according to some embodiments.

Component 1710 includes replication queue 1712 as described above. Replication queue handler 1714 writes entries into replication queue 1712 based on changes to core data 1720. As described with respect to process 400, extraction report 1716 may retrieve data from core data 1720 based on entries of replication queue 1712, and send data to HTTP handler 1718 for export to snapshot system 1730. Snapshot system 1730 includes REST service 1732 to receive the exported data and to store the data in data store 1734.

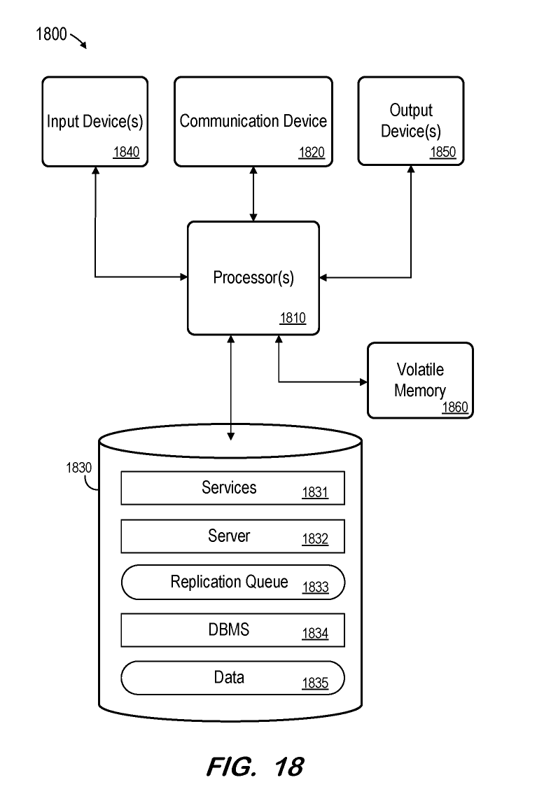

FIG. 18 is a block diagram of apparatus 1800 according to some embodiments. Apparatus 1800 may comprise a general-purpose computing apparatus and may execute program code to perform any of the functions described herein. Apparatus 1800 may comprise an implementation of data store 110 and server 120 of FIG. 1 in some embodiments. Apparatus 1800 may include other unshown elements according to some embodiments.

Apparatus 1800 includes processor(s) 1810 operatively coupled to communication device 1820, data storage device 1830, one or more input devices 1840, one or more output devices 1850 and volatile memory 1860. Communication device 1820 may facilitate communication with external devices, such as a reporting client, or a data storage device. Input device(s) 1840 may comprise, for example, a keyboard, a keypad, a mouse or other pointing device, a microphone, knob or a switch, an infra-red (IR) port, a docking station, and/or a touch screen. Input device(s) 1840 may be used, for example, to enter information into apparatus 1800. Output device(s) 1850 may comprise, for example, a display (e.g., a display screen) a speaker, and/or a printer.

Data storage device 1830 may comprise any appropriate persistent storage device, including combinations of magnetic storage devices (e.g., magnetic tape, hard disk drives and flash memory), optical storage devices, Read Only Memory (ROM) devices, etc., while memory 1860 may comprise Random Access Memory (RAM), Storage Class Memory (SCM) or any other fast-access memory.

Services 1831, server 1832 and DBMS 1834 may comprise program code executed by processor 1810 to cause apparatus 1800 to perform any one or more of the processes described herein. Embodiments are not limited to execution of these processes by a single apparatus.

Replication queue 1833 may comprise a replication queue as described herein, while data 1835 may comprise enterprise master data. Replication queue 1833 may be stored in volatile memory such as memory 1860, and data 1835 (either cached or a full database) may also be stored in volatile memory in some embodiments. Data storage device 1830 may also store data and other program code for providing additional functionality and/or which are necessary for operation of apparatus 1800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A database system comprising:
a first memory storing a plurality of sets of data, each of the plurality of sets of data being an instance of a respective logical object;
a second memory storing processor-executable process steps; and
a processor to execute the processor-executable process steps to cause the system to:
identify a first entry of a replication queue, the first entry associated with a first set of data of the plurality of sets of data;
acquire the first set of data from the first memory;
determine whether the acquired first set of data comprises currently-valid data; and
if it is determined that the acquired first set of data comprises currently-valid data, export the currently-valid data as an instance of its respective logical object to a second database system.

2. A database system according to claim 1, the processor to further execute the processor-executable process steps to cause the system to:
determine whether the acquired first set of data comprises data which is valid in the future and is not currently valid; and
if it is determined that the acquired first set of data comprises data which is valid in the future and is not currently valid, write a second entry to the replication queue, the second entry comprising an identifier of the first set of data and an indication of a future validity date of the data which is valid in the future and is not currently valid.

3. A database system according to claim 1, the processor to further execute the processor-executable process steps to cause the system to:
determine, if it is determined that the acquired first set of data does not comprise currently-valid data, whether the acquired first set of data comprises data which was valid in the past and is not currently valid; and
if it is determined that the acquired first set of data comprises data which was valid in the past and is not currently valid, delete a corresponding instance of a respective logical object of the first set of data from the second database system.

4. A database system according to claim 3, the processor to further execute the processor-executable process steps to cause the system to:
determine whether the acquired first set of data comprises data which is valid in the future and is not currently valid; and
if it is determined that the acquired first set of data comprises data which is valid in the future and is not currently valid, write a second entry to the replication queue, the second entry comprising an identifier of the first set of data and an indication of a future validity date of the data which is valid in the future and is not currently valid.

5. A database system according to claim 1, wherein determination of whether the acquired first set of data comprises currently-valid data comprises:
determination of a validity period associated with the acquired first set of data; and
determination of whether the validity period data includes a current date.

6. A database system according to claim 1, the processor to further execute the processor-executable process steps to cause the system to:
detect a change to a second set of data of the plurality of sets of data; and
write a second entry to the replication queue, the second entry comprising an identifier of the second set of data.

7. A database system according to claim 1, further comprising the second database system,
wherein the second database system stores a snapshot of the plurality of sets of data.

8. A computer-implemented method comprising:
identifying a first entry of a replication queue, the first entry comprising a replication date and being associated with a first set of data of a plurality of sets of data, each of the plurality of sets of data being an instance of a respective logical object;
determining to process the first entry by comparing the replication date to a current date;
acquiring the first set of data;
determining whether the acquired first set of data comprises currently-valid data; and
if it is determined that the acquired first set of data comprises currently-valid data, exporting the currently-valid data as an instance of its respective logical object to a database system storing a snapshot of the plurality of sets of data.

9. A method according to claim 8, further comprising:
determining whether the acquired first set of data comprises data which is valid in the future and is not currently valid; and
if it is determined that the acquired first set of data comprises data which is valid in the future and is not currently valid, writing a second entry to the replication queue, the second entry comprising an identifier of the first set of data and an indication of a future validity date of the data which is valid in the future and is not currently valid.

10. A method according to claim 8, further comprising:
determining, if it is determined that the acquired first set of data does not comprise currently-valid data, whether the acquired first set of data comprises data which was valid in the past and is not currently valid; and
if it is determined that the acquired first set of data comprises data which was valid in the past and is not currently valid, deleting a corresponding instance of a respective logical object of the first set of data from the second database system.

11. A method according to claim 10, further comprising:
determining whether the acquired first set of data comprises data which is valid in the future and is not currently valid; and
if it is determined that the acquired first set of data comprises data which is valid in the future and is not currently valid, writing a second entry to the replication queue, the second entry comprising an identifier of the first set of data and an indication of a future validity date of the data which is valid in the future and is not currently valid.

12. A method according to claim 8, wherein determining whether the acquired first set of data comprises currently-valid data comprises:
determining a validity period associated with the acquired first set of data; and
determining whether the validity period data includes a current date.

13. A method according to claim 8, further comprising:
detecting a change to a second set of data of the plurality of sets of data; and
writing a second entry to the replication queue, the second entry comprising an identifier of the second set of data.

14. A non-transitory computer-readable medium storing program code, the program code executable by a processor of a computing system to cause the computing system to:
identify a first entry of a replication queue, the first entry associated with a first set of data of a plurality of sets of data, each of the plurality of sets of data being an instance of a respective logical object;
acquire the first set of data;
determine whether the acquired first set of data comprises currently-valid data; and
if it is determined that the acquired first set of data comprises currently-valid data, export the currently-valid data as an instance of its respective logical object to a database system storing a snapshot of the plurality of sets of data.

15. A medium according to claim 14, the program code further executable by the processor of the computing system to cause the computing system to:
determine whether the acquired first set of data comprises data which is valid in the future and is not currently valid; and
if it is determined that the acquired first set of data comprises data which is valid in the future and is not currently valid, write a second entry to the replication queue, the second entry comprising an identifier of the first set of data and an indication of a future validity date of the data which is valid in the future and is not currently valid.

16. A medium according to claim 14, the program code further executable by the processor of the computing system to cause the computing system to:
determine, if it is determined that the acquired first set of data does not comprise currently-valid data, whether the acquired first set of data comprises data which was valid in the past and is not currently valid; and
if it is determined that the acquired first set of data comprises data which was valid in the past and is not currently valid, delete a corresponding instance of a respective logical object of the first set of data from the second database system.

17. A medium according to claim 16, the program code further executable by the processor of the computing system to cause the computing system to:
determine whether the acquired first set of data comprises data which is valid in the future and is not currently valid; and
if it is determined that the acquired first set of data comprises data which is valid in the future and is not currently valid, write a second entry to the replication queue, the second entry comprising an identifier of the first set of data and an indication of a future validity date of the data which is valid in the future and is not currently valid.

18. A medium according to claim 14, wherein determination of whether the acquired first set of data comprises currently-valid data comprises:
determination of a validity period associated with the acquired first set of data; and
determination of whether the validity period data includes a current date.

19. A medium according to claim 14, the program code further executable by the processor of the computing system to cause the computing system to:
detect a change to a second set of data of the plurality of sets of data; and
write a second entry to the replication queue, the second entry comprising an identifier of the second set of data.
